(19) United States
(12) Patent Application Publication
(10) Pub. No.: US 2009/0220910 A1
(43) Pub. Date: Sep. 3, 2009

(54) Disposable Dental Prophy Angle With Sectional Engaged Housing

(76) Inventor: Daniel Wang, Walnut, CA (US)

Correspondence Address: Daniel Y. Wang, 21078 Commerce Pointe Drive, Walnut, CA, 91789, US

(21) Appl. No.: 12/040,890

(22) Filed: Mar. 1, 2008

(51) Int. Cl. A61C 3/06; A61C 17/00

(52) U.S. Cl. 433/125; 433/126

(57) ABSTRACT

A disposable dental angle with a housing consisting of two sections is provided. The vertical aperture of the head section of the housing allows insertion of a driven rotor such that the driven rotor is properly positioned. The horizontal aperture of the tail section of the housing allows insertion of a driving shaft such that the driving shaft is properly positioned. The front stepped end of the tail section engages the horizontal aperture of the head section firmly such that the two sections form a right angle. This ensures that the gear of the driven rotor is properly coupled to the matching gear of the driving shaft. Hence the driving shaft transfers the rotation from a dental tool to the driven rotor for the purpose of tooth cleaning using a cleaning cup.

### FIELD OF THE INVENTION

The present invention relates to a disposable dental appliance and more particularly to a dental prophylaxis angle (or “prophy angle”) used for cleaning teeth, and more especially to those to be disposed of after each patient to avoid cross infection.

### BACKGROUND OF THE INVENTION

A conventional prophy angle is used in dental treatments to remove plaque and to polish the surface of the dentin of teeth. A prophy cup is secured to the angle and is rotated by a drive mechanism, typically a gear drive. The prophy cup is shaped to retain a desired amount of prophy paste which is used to clean a patient's teeth.

A typical drive mechanism is a gear connection between a driving gear shaft and a driven gear rotor at a right angle. The driving shaft is rotated by a dental drive means of a dental tool (such as a dental handpiece) with speeds ranging from 2,000 to 5,000 rpm. The rotation is transferred to the driven rotor by the gearing mechanism resulting in rotation of the attached prophy cup at a right angle.

Maintaining a secure and consistent connection between the driving and driven gears during high speed operation, especially for plastic materials, has been a challenge for many years. To this end, gear material, gear shape, gear position, and lubrication have been studied and improved by the disclosures of many previous patents such as U.S. Pat. Nos. 6,203,322, 5,964,590, 5,749,728, 5,730,595, 5,645,426, 5,120,220, and 5,040,978. However, many of the prophy angle products in the present market exhibit operating life problems because of insecure gearing connections which cause inconvenience for dentists and hygienists.

Thus, the present invention provides a two-section housing with features that ensure the driving gear remains properly engaged to the driven gear during operating.

### BRIEF SUMMARY OF THE INVENTION

The invention is directed to a dental prophy angle that has an integrally formed housing, which incorporates two gears (driving gear and driven gear) and a removable prophylaxis head attachment, also called the prophylaxis cup (or “prophy cup”), and which translates rotation from a dental power source to the head attachment through these gears. More specifically, the driving gear shaft, which receives the dental power source on one end and engages with the driven gear on the other end, translates the rotation to the driven gear rotor at an angle. The entire prophy angle is made of inexpensive plastic and is discarded after a single treatment, thus avoiding cross-infection as well as the expense and inconvenience of sterilization.

One aspect of the invention is that the two gears are engaged perpendicularly to each other on their inner sides of contact, instead of their outer sides, so that the rotation direction of the prophy cup will be the same as, instead of opposite, that of the driving gear and of other dental treatment devices connected with the driving gear. The consistency in rotation direction makes practitioners feel more comfortable.

Another aspect of prominent benefit of the present invention lies in the mating of the gears. Due to the necessary existence of operating tolerances in the sizing of the gears, as the prophy angle operates the inner contact engagement makes the mating of the gears closer when the driven rotor is pressed toward to the driving shaft by the force from the prophy cup. Contrarily, an outer contact engagement reduces the mating area of the gears as the driven rotor is pushed away from the driving gear shaft by the pressure of the prophy cup as the prophy angle operates.

A further aspect of the invention is the two-section housing comprising a head section and a tail section which are tightly engaged and either soldered ultrasonically or glued by adhesive to form an integral piece. The integral nature of the housing, combined with the several positioning aspects described below, ensures the continuous engagement of the gears.

A still further aspect of the invention is the positioning ring on the driving shaft which, having a larger diameter than the hole in the front of the tail section of the housing and resting just in front of this hole, ensures that the driving shaft is blocked in axial position during operation.

Yet another aspect of the invention is a pin extending from the front of the driving shaft which is positioned within a circumferential groove on the driven rotor when the two sections of the housing are engaged. This arrangement provides a secure means for preventing the driven rotor from falling out while allowing it to rotate freely without much extra friction. The inner-side contact gearing arrangement tends to eject the driven rotor from the housing because the gear on the driving shaft applies an outward force to the rotating driven gear. Thus, the reliability of the pin-groove holding mechanism is an important aspect of the present invention which ensures in a simple way that the driven-gear rotor remains in position securely for much less cost in comparison with other similar products in market.

The last aspect of the present invention is the set of three or more azimuthal positioning control ridges located at the top of the head section of the housing, which receives the driven rotor and ensures that the head of the driven rotor is rotated accurately around its axis during operation without being pushed off-axis.

Other details and features of the invention will be in part apparent and in part pointed out hereinafter.

### BRIEF DESCRIPTION OF THE DRAWINGS

The invention will be further described in conjunction with the attached drawings of which:

FIG. 1 is a perspective view of an assembled prophy angle, where 10—Housing—tail section, 20—Housing—head section, 50—Joint location.

FIG. 2 is a cross-section view of the prophy angle shown in FIG. 1, where 10—Housing—tail section, 20—Housing—head section, 30—Driving gear shaft, 40—Driven gear rotor.

FIG. 3 is a perspective view of the head section and the tail section of the housing, prior to assembly, which shows a protruded ridge near the front of the tail section and a sunken slot in the rear of the tail section. The ridge is inserted into the slot to provide azimuthal alignment, where 31—Protruded ridge on tail section, 41—Sunken slot in head section.

FIG. 4 is a perspective view of the tail section of the housing assembled with the driving shaft, where 31—Driving shaft head, 12—Front end of tail section of the housing.

FIG. 5 shows the protruded ridges inside the head section of the housing, used for centering the driven gear rotor, where 41—Protruded ridges, 43—extended arm of the middle ridge.

FIG. 6 is a perspective view of the assembled gears in the positions they assume inside the housing, where 30—Driving Gear, 40—Driven Gear.

### DETAILED DESCRIPTION OF THE INVENTION

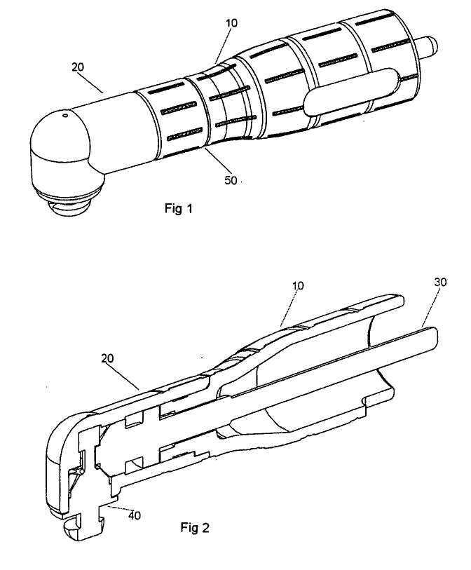

Referring first to FIG. 1 and FIG. 2, which is a cross-sectional view of the prophy angle shown in FIG. 1, of the drawings, one preferred embodiment of the prophy angle of the present invention is shown. On FIG. 1, the head section 20 and tail section 10 are jointed at the joint location 50, forming the housing of the prophy angle. On FIG. 2, the driving gear shaft 30 and driven gear rotor 40 are assembled inside the head section 20, staying inside the assembled housing which consists of the head section 20 and the tail section 10. A powered dental handpiece of conventional type (not shown) is supposed to be coupled to the tail of the driving shaft 30 and a snap-on rubber prophy cup with prophy paste on (not shown) is supposed to be connected to the cup holder head of the driven rotor 40.

FIG. 3 is a perspective view of the head and tail sections before assembled inside housing. The protruded ridge 11 on the tail section matches the sunken slot 21 on the head section. Hence when they are assembled together, the head section and tail section are firmly jointed at the joint location with a correct azimuthally oriented direction.

The angle housing is hollow such that the longitudinal and transverse passageways inside the head section and tail section which are jointed at the joint location of the housing are structured therein for housing the gear-driving mechanism. Longitudinal passageway where driving gear shaft and its joint structure are supposed to be housed is preferably substantially perpendicular to transverse passageway where driven gear rotor is supposed to be housed.

Driving gear shaft and driven gear rotor have tooth-matched gears that produce a gearing action that translates rotation of driving gear shaft into rotation of driven gear rotor. The orientation of the translated rotation will be turned 90 degrees to the source rotary unit if the axis of driven rotor is perpendicular to the axis of driving shaft.

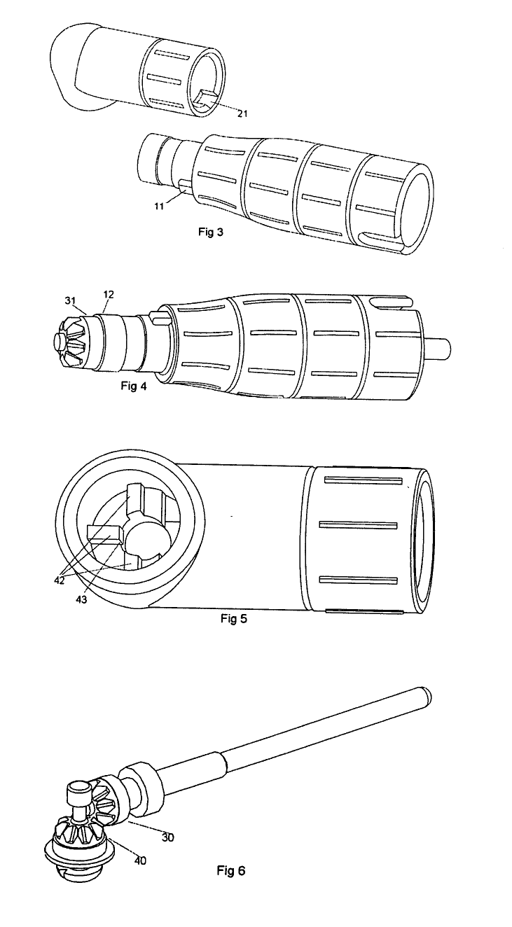

FIG. 4 represents a perspective view of the tail section 10 of the housing after the driving gear shaft 30 is assembled on. The driving head 31 of the driving gear shaft 30 is. positioned on the front end 31 of the tail section 10 to assure the gear transferring between the driving shaft and the driven rotor is proper and the axial movement of driving shaft from its position relative to driven rotor is prevented when the driven gear rotor is assembled on.

In FIG. 5, three azimuthal positioning control protruded ridges 42 are located around the head hole for the driven gear rotor so that when the driven rotor is rotated, the head of the rotor are surrounded by the protruded ridges 42 to assure the rotation is centered by the axis of the rotor. The middle ridge among those three is extended at its arm 43 so that when the driven rotor is assembled into the head section of the housing, because of the extended arm length, the middle ridge will be positioned within a circumferential groove on the driven rotor so that the driven rotor is rotated accurately around its axis during operation without dropping out during operation.

FIG. 6 represents a perspective view of the driving gear shaft 30 and the driving gear rotor 40 assembled inside the housing. The extended pin at the head of the driving shaft is positioned within a circumferential groove on the driven rotor, so as to prevent the driven rotor from dropping out during operation.

In view of the above, it will be seen that the objects of the invention are achieved.

Although specific examples of the present invention and its application are set forth herein, they are not intended to be exhaustive or limiting of the invention. These illustrations and explanations are intended to acquaint others skilled in the art with the invention, its principles, and its practical application, so that others skilled in the art may adapt and apply the invention in its numerous forms, as may best suit the requirements of a particular use.

I claim:

1. A disposable dental prophylaxis angle comprising:
a driving shaft including a gear head, a shaft neck, a shaft shoulder and a shaft tail;
a driven rotor including a rotor head, a rotor neck, a gear shoulder, a cup flange, a cup neck, and a cup holder;
a housing including a head section and a tail section which can be tightly engaged and soldered ultrasonically or glued together using an adhesive to form an integral piece;
means for coupling said driving shaft in said tail section to said driven rotor in said head section so as to maintain continuous engagement of driving and driven gears during operation;
means for positioning said driving shaft in said tail section to said driven rotor in said head section so as to prevent said driven rotor from dropping out during operation by an extended pin on said driving shaft positioned within a circumferential groove on said driven rotor.

2. The dental prophylaxis angle of claim 1, wherein said tail section of said housing contains said driving shaft, positioned so as to permit coupling its tail with a dental drive means of a dental tool and transferring rotation to said gear head of said driving shaft which protrudes through a hole at the front end of said tail section to connect to said head section.

3. The dental prophylaxis angle of claim 1, wherein said head section of said housing contains said driven rotor, positioned so as to permit coupling of said driven rotor with a prophy cup at the bottom end of said head section.

4. The dental prophylaxis angle of claim 1, wherein said driving shaft is connected to a dental tool driving end at the rear end of said tail section.

5. The dental prophylaxis angle of claim 1, wherein said driving shaft is connected to said driven rotor by a gear connection, said driving shaft being at an angle, preferably 90 degrees, with respect to said rotor.

6. The driving shaft of claim 2, further comprising one or more positioning rings with suitable diameter to ensure said driving shaft is unable to move in the axial direction, accurately retaining said driving shaft in location so that said gear head is connected properly with said gear shoulder of said driven rotor during operation.

7. The head section of claim 3, further comprising three or more positioning control ridges located around the top of said driven rotor so that said driven rotor is rotated accurately around its axis during operation without being pushing forwards.

8. The head section of claim. 3, further specifying the middle ridge of said three positioning control ridges with an extended arm toward to the center of said driven rotor which provides an additional means for positioning said driven rotor so as to prevent said driven rotor from dropping out during operation by said extended arm on said middle ridge positioned within a circumferential groove on said driven rotor so that said driven rotor is rotated accurately around its axis during operation.
